(19) United States
(12) Patent Application Publication
(10) Pub. No.: US 2024/0068484 A1
(43) Pub. Date: Feb. 29, 2024

(54) FAN WITH DEBRIS MITIGATION

(71) Applicant: Apple Inc., Cupertino, CA (US)

(72) Inventors: Jesse T. DYBENKO, Santa Cruz, CA (US); Arash NAGHIB LAHOUTI, San Jose, CA (US); Jason C. SAUERS, Sunnyvale, CA (US); Jeffrey R. KAPPER, San Jose, CA (US); Sivesh SELVAKUMAR, San Francisco, CA (US); David J. DUNSMOOR, San Jose, CA (US)

(21) Appl. No.: 18/225,043

(22) Filed: Jul. 21, 2023

Related U.S. Application Data
(60) Provisional application No. 63/401,512, filed on Aug. 26, 2022.

(51) Int. Cl. F04D 29/28; F04D 29/42; F04D 29/62; F04D 29/70

(52) U.S. Cl. CPC F04D 29/281; F04D 29/4226; F04D 29/626; F04D 29/703

(57) ABSTRACT

A head-mountable device can include a fan that effectively manages heat while also mitigating the intrusion of particles and other debris. Fans can include a protrusion that creates a tortuous pathway to direct incoming particles away from sensitive regions. Fans can include openings to allow particles to exit the fan enclosure and avoid interaction with the impeller. Fans can include a variable spacing between the impeller and the base plate to avoid collection of particles. Fans can include an adhesive pad that collects and retains particles at a location that does not interfere with rotation of the impeller.

### CROSS-REFERENCE TO RELATED APPLICATION

This application claims the benefit of U.S. Provisional Application No. 63/401,512, entitled “FAN WITH DEBRIS MITIGATION,” filed Aug. 26, 2022, the entirety of which is incorporated herein by reference.

### TECHNICAL FIELD

The present description relates generally to cooling devices, and, more particularly, to fans for head-mountable devices with debris mitigation features.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of a head-mountable device, according to some embodiments of the present disclosure.

FIG. 2 illustrates a perspective view of a fan for a head-mountable device, according to some embodiments of the present disclosure.

FIG. 3 illustrates a sectional view of an assembly of the head-mountable device of FIG. 1 including the fan of FIG. 2 in operation to generate a flow, according to some embodiments of the present disclosure.

FIG. 4 illustrates another sectional view of the assembly of FIG. 3 with the fan of FIG. 2 in stasis and particles entering through the outlet, according to some embodiments of the present disclosure.

FIG. 5 illustrates a perspective and sectional view of a fan having an annular ring to direct incoming particles, according to some embodiments of the present disclosure.

FIG. 6 illustrates a perspective and sectional view of a fan having an annular ring to direct incoming particles, according to some embodiments of the present disclosure.

FIG. 7 illustrates a sectional view of a fan having a base plate with variable thickness, according to some embodiments of the present disclosure.

FIG. 8 illustrates an exploded view of a fan having a base plate forming openings, according to some embodiments of the present disclosure.

FIG. 9 illustrates a bottom view of a fan having a base plate forming openings and an adhesive pad, according to some embodiments of the present disclosure.

FIG. 10 illustrates a sectional view of the fan of FIG. 9, according to some embodiments of the present disclosure.

FIG. 11 illustrates an exploded view of a fan having a base plate forming openings, according to some embodiments of the present disclosure.

FIG. 12 illustrates a perspective and sectional view of the fan of FIG. 11, according to some embodiments of the present disclosure.

FIG. 13 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

Components of a head-mountable device can generate heat during operation. The performance of electronic devices are often limited by their ability to effectively dissipate the heat generated by computing and other workloads. Excessive heat for long durations of time can damage the components of the head-mountable device and cause discomfort to the user. Heat can be mitigated in a number of ways, including with active mechanisms (e.g., fans, blowers, air movers, and the like) that are integrated into the head-mountable device. In order to dissipate heat effectively within a small form factor, active cooling is sometimes used. Active cooling refers to a thermal architecture wherein heat is dissipated via forced convection.

An active cooling device (e.g., fans, blowers, air movers, and the like) can generate a flow of air from an inlet to an outlet thereof. Such inlets and outlets can define a pathway that receives air from and/or delivers air to an environment external to the head-mountable device. However, by providing such exposure to an external environment, the fan is susceptible to intrusion by particles or other debris from the external environment. In particular, when the fan is not in operation, such particles can collect and become lodged between the parts of the fan. In such a condition, the fan may encounter difficultly resuming operation due to the introduction of particles between moving parts of the fan. In particular, particles lodged between the stationary parts (i.e., fan housing) and moving parts (i.e., rotor, impeller, etc.) can cause the fan to stall.

Systems of the present disclosure can provide fans that mitigate the intrusion of particles and other debris. Fans can include a protrusion that creates a tortuous pathway to direct incoming particles away from sensitive regions. Fans can include openings to allow particles to exit the fan. Fans can include a variable spacing between the stationary parts (i.e., fan housing) and moving parts (i.e., rotor, impeller, etc.) to avoid collection of particles. Fans can include an adhesive pad that collects and retains particles at a location that does not interfere with operation of the impeller.

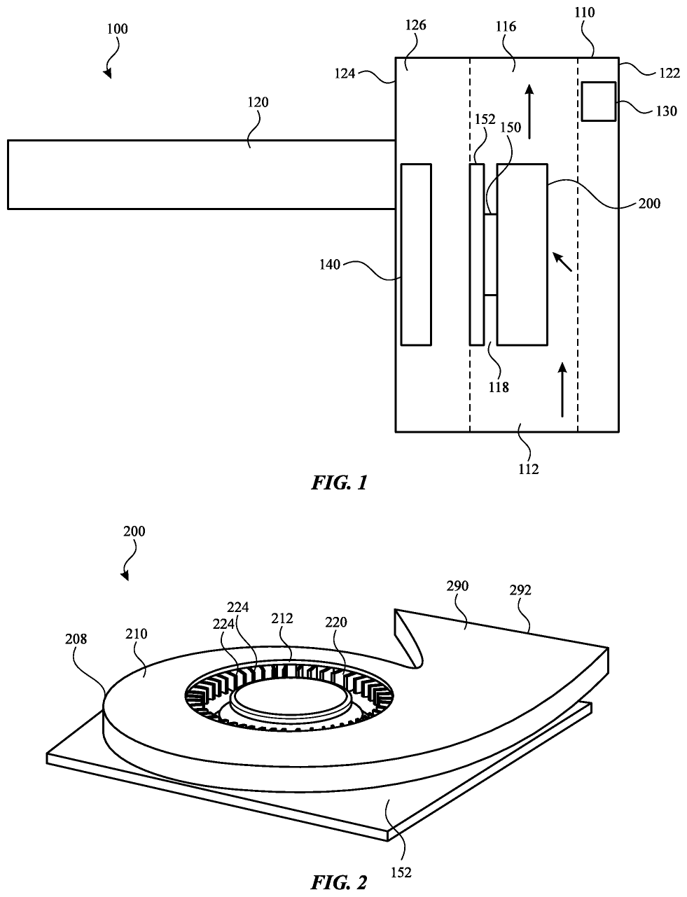

These and other embodiments are discussed below with reference to FIGS. 1-13. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 that is worn on a head of a user. The frame 110 can be positioned in front of the eyes of a user to provide information within a field of view of the user. The frame 110 can provide nose pads or another feature to rest on a user's nose. The frame 110 can be supported on a user's head with the head engager 120. The head engager 120 can wrap or extend along opposing sides of a user's head. The head engager 120 can include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the frame 110 in their assembled position. For example, the frame 110 can enclose and support various internal components (including for example integrated circuit chips, processors, memory devices, cameras, displays, lenses, and other circuitry) to provide computing and functional operations for the head-mountable device 100, as discussed further herein. Any number of components can be included within and/or on the frame 110 and/or the head engager 120.

The frame 110 can include and/or support one or more cameras 130. The cameras 130 can be positioned on or near an outer side of the frame 110 to capture images of views external to the head-mountable device 100. The captured images can be used for display to the user or stored for any other purpose.

The head-mountable device can be provided with displays that provide visual output for viewing by a user wearing the head-mountable device. As further shown in FIG. 1, one or more displays 140 can be positioned on an inner side 124 of the head-mountable device 100, for example within an eye chamber 126. For example, a pair of displays 140 can be provided, where each display 140 is movably positioned to be within the field of view of each of a user's two eyes. Each display 140 can be adjusted to align with a corresponding eye of the user. For example, each display 140 can be moved along one or more axes until a center of each display 140 is aligned with a center of the corresponding eye.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment relates to a physical world that people can sense and/or interact with without necessarily requiring the aid of an electronic device. A computer-generated reality environment relates to a wholly or partially simulated environment that people sense and/or interact with the assistance of an electronic device. Examples of computer-generated reality include mixed reality and virtual reality. Examples of mixed realities can include augmented reality and augmented virtuality. Some examples of electronic devices that enable a person to sense and/or interact with various computer-generated reality environments include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable device can have an integrated opaque display, have a transparent or translucent display, or be configured to accept an external opaque display (e.g., smartphone).

Referring again to FIG. 1, the head-mountable device can be provided with one or more flow channels that extend through at least a portion of the frame thereof to provide cooling to components of the head-mountable device. As shown in FIG. 1, the flow channels can include and/or be connected to a system inlet 112. The system inlet 112 can provide airflow directly to the fan 200 and/or one or more components of the head-mountable device 100, such as a circuit component 150. The air received by the system inlet 112 can be directed to a system outlet 116 and/or other outlets for exhaust out of the head-mountable device 100 by the fan 200.

While the system inlet 112 is depicted at a bottom portion of the frame 110 and the system outlet 116 is depicted at a top portion of the frame 110, it will be recognized that inlets, outlets, and flow channels there between can be positioned at any portion of the head-mountable device 100. The system outlet 116 can be provided at a location that will allow exiting air to exhaust to an environment that is not disruptive to the user. For example, the system outlet 116 can be provided at a location and in and orientation that directs hot air away from the user. Multiple flow channels can be interconnected, such that multiple inlets and/or multiple outlets are connected to each other.

One or more fans 200 can be operated to provide cooling to one or more circuit components 150 of the head-mountable device 100. The circuit component 150 can be an electrical component that generates heat during operation. The circuit component 150 can be a component of a circuit board 152. The circuit component 150 can be operably and structurally coupled to the circuit board 152. A portion of the fan 200 can be thermally connected to the circuit component 150.

The fan 200 can receive a flow of air from a system inlet 112 and direct the flow of air to a system outlet 116. For example, the fan 200, the circuit component 150, and/or the circuit board 152 can be positioned within an internal chamber 118 (e.g., plenum chamber) of the head-mountable device 100.

While several components are shown within the frame 110, it will be understood that some or all of these components can be located anywhere within or on the head-mountable device 100. For example, one or more of these components can be positioned within the head engager 120 of the head-mountable device 100.

Referring now to FIG. 2, the fan can provide features for moving air across surfaces for dissipating heat. As shown in FIG. 2, the fan 200 can include a fan housing 208 that includes a cover 210 over an impeller 220. The cover 210 can form a fan inlet 212, for example through a top surface thereof. The cover 210 can include or be connected to an exhaust duct 290 that forms a fan outlet 292 of the fan 200.

The impeller 220 of the fan 200 can be positioned to receive air through the fan inlet 212 and direct the air to the fan outlet 292. The fan 200 can include a motor to drive rotation of the impeller 220. For example, the fan 200 can include a stator and an impeller 220 configured to rotate about the stator. The impeller 220 can include multiple blades 224 that extend radially outwardly away from the central hub of the impeller. As the impeller 220 rotates, the blades 224 receive air from the fan inlet 212 and direct the air radially outwardly and toward the fan outlet 292. The impeller 220 can be stabilized by one or more bearings between the impeller 220 and the stator. The bearing can include a fluid hydrodynamic bearing, for example with oil or another fluid between the impeller 220 and the stator. It will be understood that other types of bearings are contemplated, including mechanical bearings, journal bearings, plain bearings, ball bearings, and the like. The bearing can provide radial and/or axial support to the impeller 220 as it rotates about the stator.

The impeller 220 can direct air or another gas within, against, or across one or more components of the fan 200. The fan 200 can be operated based on one or more operating parameters that are controllable during use. The operating parameters can be determined, at least in part, based on a demand for cooling (e.g., based on a temperature of one or more components). The operating parameters can be further determined based on acceptable sound levels and characteristics to be produced by the fan 200 and along the flow channel.

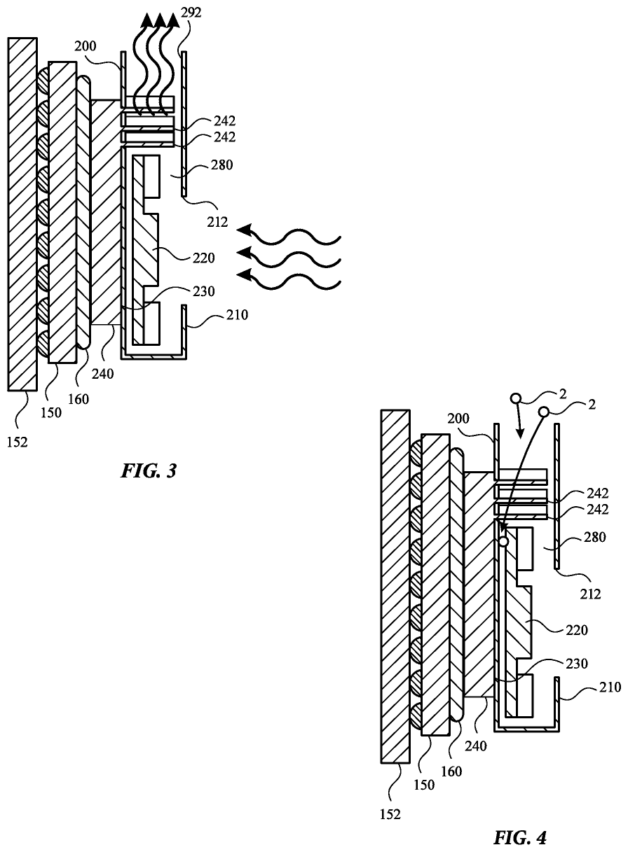

Referring now to FIGS. 3 and 4, the fan can be thermally connected to components to be cooled. As shown in FIG. 3, the fan housing 208 can further include a base plate 230. The cover 210 and the base plate 230 of the fan housing 208 can, together, define an interior space 280 there between. The impeller 220 can be positioned within the interior space 280 and mounted to the base plate 230. As such, the base plate 230 provides structural support to the impeller 220 for stable operation (e.g., during rotation).

A heat sink 240 can provide one or more fins 242 between the interior space 280 and the fan outlet 292 formed by the exhaust duct 290. The heat sink 240 is thermally connected to the circuit component 150, which is operably and structurally coupled to the circuit board 152. The heat sink 240 can be thermally connected to the circuit component 150 by a direct connection (e.g., no intervening structure) or by a thermal interface 160. For example, a thermal paste or other thermally conductive material can be provided to thermally and/or structurally connect the circuit component 150 to the heat sink 240.

The base plate 230, the heat sink 240, and/or the fins 242 can be of a metal or other material having high thermal conductivity. The material can provide high rigidity and strength to provide support to components mounted to the base plate 230 and to securely mount to other components (e.g., the frame) of the head-mountable device.

The cover 210 can be of a material that provides protection to the impeller 220 and any other components in the interior space. The material can be plastic, metal, and/or another material. The cover 210 can be a monolithic, unitary, and/or unibody structure, rather than an assembly of parts.

As shown in FIG. 3 and FIG. 4, the fan 200 can generate a flow of air from an inlet (e.g., system inlet 112 and/or fan inlet 212) to an outlet (e.g., system outlet 116 and/or fan outlet 292). It will be understood that the system outlet 116 can be directly connected to the fan outlet 292, such that all air directed through the fan outlet 292 can be further directed to the system outlet 116. Such inlets and outlets can define a pathway that receives air from and/or delivers air to an environment external to the head-mountable device. During operation of the fan 200, the air flow can be maintained such that any particles or other debris travelling with the air flow moves through the fan 200 without remaining therein. Furthermore, the movement of the impeller 220 can disrupt and propel any resting particles until they are ejected from the fan 200.

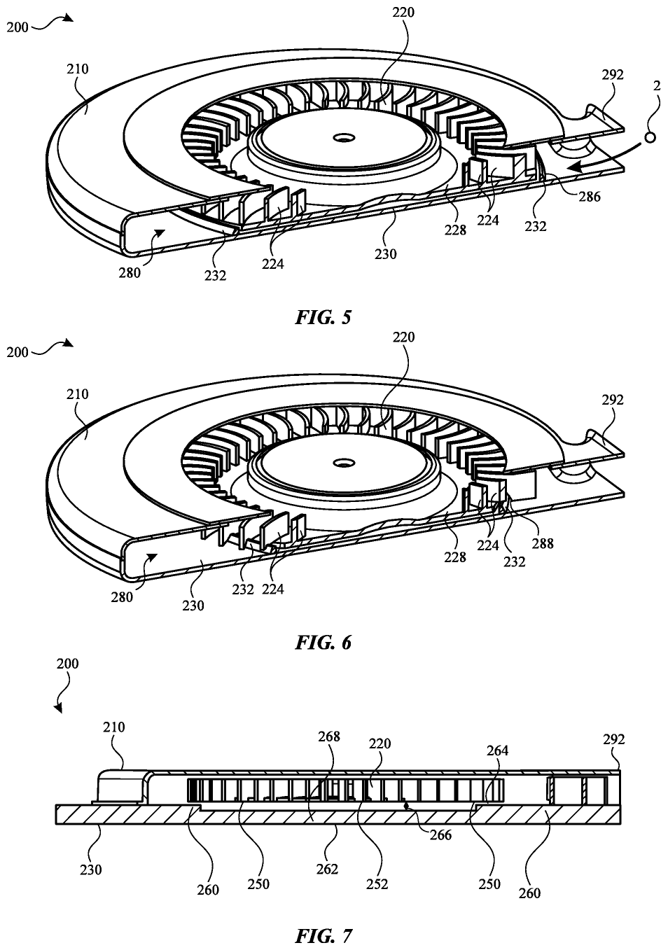

However, as shown in FIG. 5, by providing such exposure to an external environment, the fan 200 is susceptible to intrusion by particles or other debris from the external environment. In particular, when the fan 200 is not in operation (e.g., when the impeller 220 is not rotating), particles 2 can collect and become lodged between the moving and stationary parts of the fan 200. For example, the particles 2 can enter through the system inlet 112 and into the fan inlet 212 and/or through the system outlet 116 and into the fan outlet 292 and become lodged between the stationary parts (i.e., fan housing, base plate, etc.) and moving parts (i.e., rotor, impeller, etc.) of the fan 200. In such a condition, the fan 200 may encounter difficultly resuming operation due to the introduction of particles between moving and stationary parts of the fan 200. In particular, particles 2 lodged between the impeller 220 and the base plate 230 can cause the impeller 220 to stall.

It can be desirable to provide features that mitigate the collection of such particles while the fan 200 is not in operation without reducing the effectiveness of the fan while it is in operation.

Referring now to FIG. 5, a fan can include features that create a tortuous pathway to prevent the incoming particles from entering the sensitive regions. For example, as shown in FIG. 5, a protrusion 232 can extend from the base plate 230 to block and/or redirect a pathway of an incoming particle 2. For example, the protrusion 232 can be positioned between at least a portion of the impeller 220 and the fan outlet 292. The protrusion 232 can extend toward the cover 210 while allowing an air flow pathway over the protrusion between the impeller 220 and the fan outlet 292.

The impeller 220 can be formed with a support disk 228 on one side of the blades 224. Where a support disk 228 is provided, such as is shown in FIG. 5, the protrusion 232 can extend from the base plate 230 to at least a height of a portion of the support disk 228. Where blades 224 are provided, the protrusion 232 can extend from the base plate 230 to at least a height of one or more of the blades 224. As such, the protrusion 232 can shield and/or occupy a space between the base plate 230 and the support disk 228. It will be understood that a tortuous pathway around the protrusion 232 can connect the fan outlet 292 to the space between the base plate 230 and the support disk 228. However, the protrusion can be formed such that incoming particles 2 are instead deflected to above the support disk 228, so that they do not lodge between the base plate 230 and the support disk 228.

In some embodiments, as further shown in FIG. 5, the protrusion 232 can be formed as an annular ring or closed loop. Such a closed loop can surround a periphery of the impeller 220. For example, the annular ring can encircle the support disk 228 and/or a portion of each of the blades 224.

In some embodiments, as further shown in FIG. 5, the protrusion 232 defines a surface 286 facing away from the impeller 220. This surface 286 can be that on which the particle 2 is incident upon entry through the fan outlet 292. The surface 286 can be formed to direct the particle away from the space between the base plate 230 and the impeller 220. For example, the surface can form an angle that is oblique with respect to the base plate 230 to form a ramp.

Referring now to FIG. 6, the protrusion 232 can overlap with at least a portion of the impeller 220. For example, the blades 224 can be positioned between the cover 210 and the base plate 230, and each of the blades can form a notch 288. The protrusion 232 extends from the base plate 230 and into at least some of the notches 288. As the impeller 220 rotates, the notches 288 pass over the protrusion 232 without physical contact.

Where a support disk 228 of the impeller 220 is provided, such as is shown in FIG. 6, the protrusion 232 can extend from the base plate 230 to at least a height of a portion of the support disk 228. In some embodiments, as further shown in FIG. 6, the protrusion 232 can be formed as an annular ring. For example, the annular ring can encircle the support disk 228 without encircling the blades 224, but instead protruding towards the blades 224 and into the notches 288. As such, the protrusion 232 can block a space between the base plate 230 and the support disk 228. It will be understood that a tortuous pathway around the protrusion 232 can connect the fan outlet 292 to the space between the base plate 230 and the support disk 228. However, the protrusion can be formed such that incoming particles are instead deflected to above the support disk 228, so that they do not lodge between the base plate 230 and the support disk 228.

It will be understood that any protrusion 232 disclosed herein need not form an annular ring and that a variety of other shapes are contemplated, such as an arc, a flat wall, and the like. It will be understood that any number of protrusions 232 can be provided. For example, both the protrusion of FIG. 5 (i.e., overlapping the impeller 220) and the protrusion of FIG. 6 (i.e., surrounding the impeller 220) can be provided in combination.

In some embodiments, a distance between any protrusion 232 disclosed herein and the impeller 220 (e.g., the support disk 228 and/or the blades 224) can be smaller than a distance between the base plate 230 and the impeller 220 (e.g., the support disk 228). The smaller distance between the protrusion 232 and the impeller 220 can serve to block particles having a dimension that is greater than such a distance. As such, only particles smaller than such a distance can pass the protrusion 232. When such small particles are between the base plate 230 and the impeller 220, the particles will not be large enough to extend to both the base plate 230 and the impeller 220 and will thereby be unable to lodge therein or arrest operation of the impeller 220.

Referring now to FIG. 7, the base plate can have features that facilitate particle blocking and promote impeller operation. For example, as shown in FIG. 7, the base plate 230 can have a variable profile at different portions thereof and with respect to the impeller 220. For example, the base plate can form a base plate central portion 262 and one or more base plate peripheral portions 260. The impeller 220 can form an impeller central portion 252 and one or more impeller peripheral portions 250. A distance 266 between the base plate central portion 262 and the impeller central portion 252 is greater than a distance 264 between the base plate peripheral portion 260 and the impeller peripheral portion 250. The smaller distance 264 between the base plate central portion 262 and the impeller central portion 252 can serve to block particles having a dimension that is greater than the distance 264. As such, only particles smaller than such a distance can pass the gap defined by the distance 264. When such small particles are between the base plate central portion 262 and the impeller central portion 252, the particles will not be large enough to span the distance 266 to contact both the base plate central portion 262 and the impeller central portion 252 and will thereby be unable to lodge therein or arrest operation of the impeller 220. It will be understood that a number of variations can be provided, including any number of different distances and/or transitions there between.

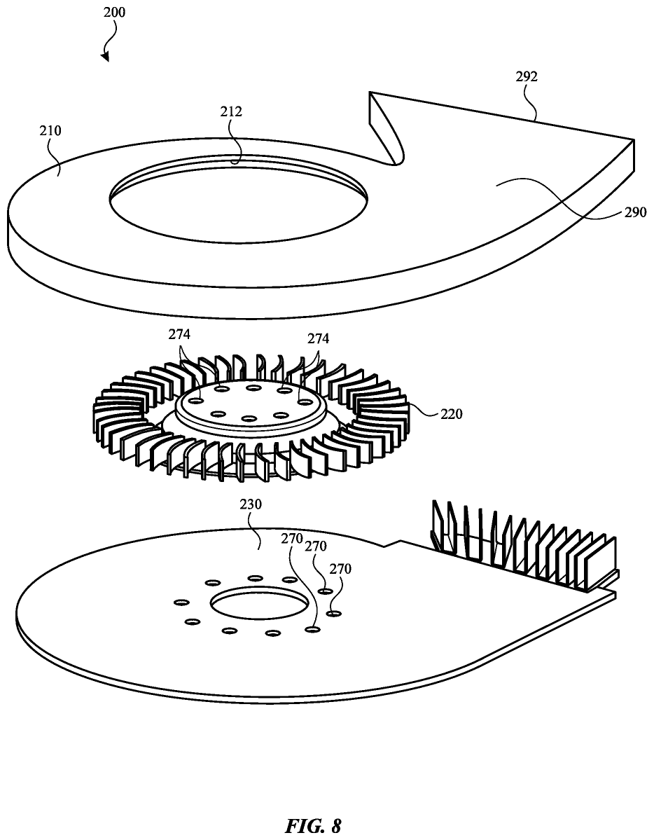

Referring now to FIG. 8, the base plate can have features that facilitate particle evacuation and/or capture. For example, as shown in FIG. 8, the base plate 230 can define one or more openings 270 that extend entirely through the base plate 230. The impeller 220 can be positioned to overlap at least some of the openings 270 of the base plate 230. When particles are introduced between the base plate 230 and the impeller 220, the particles can be provided with an exit from such a region through the openings 270. The openings 270 can be connected to an external environment or a collection chamber for releasing and/or capturing the particles. It will be understood that any number of openings 270 can be provided in any arrangement. It will be further understood that the openings 270 can have any size and/or dimension to facilitate particle removal. It will be understood that openings can be provided at any location, including other than the base plate 230. Where the openings 270 are provided at a base plate 230, such openings can optionally be covered, as described further herein.

By further example, the impeller 220 can define one or more openings 274 that extend entirely through the impeller 220. When particles are introduced between the impeller 220 and the base plate 230, the particles can be provided with an exit from such a region through the openings 274 extending through the impeller 220. The openings 274 can be connected to a collection chamber for capturing and retaining the particles. Where the openings 274 are provided at the impeller 220, such openings can be covered, as described further herein, to prevent introduction of particles into the space between the base plate 230 and the impeller 220. It will be understood that any number of openings 274 can be provided in any arrangement. It will be further understood that the openings 274 can have any size and/or dimension to facilitate particle removal. It will be understood that openings can be provided at any location, including other than the impeller 220.

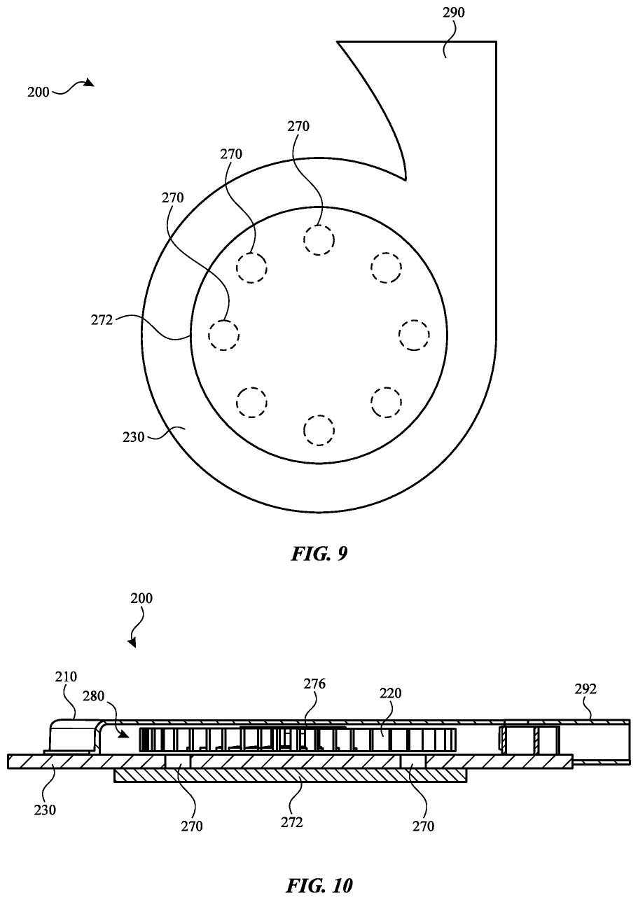

Referring now to FIGS. 9 and 10, a fan can include a retention mechanism that captures particles. For example, as shown in FIG. 9, a pad 272 can be provided on a side of the base plate 230 facing and/or covering the openings 270. In such an embodiment, the openings 270 can be the same or similar to those described elsewhere herein. As shown in FIG. 10, the pad 272 can be positioned on a side of the openings that is opposite the impeller 220, such as on an outer side of the base plate 230. Rather than releasing the particles that pass through the openings 270, the pad 272 can capture the particles and retain them away from the space between the impeller 220 and the base plate 230.

By further example, as shown in FIG. 10, a pad 276 can be provided on a side of the impeller 220 facing and/or covering openings (not shown in FIG. 10) extending through a portion of the impeller 220. As shown in FIG. 10, the pad 276 can be positioned on a side of the openings that is opposite the base plate 230, such as on an outer side of the impeller 220 (e.g., facing the cover 210). Rather than releasing the particles that pass through the openings of the impeller 220, the pad 276 can capture the particles and retain them away from the space between the impeller 220 and the base plate 230.

Once the particles are removed from the interior space 280 containing the impeller 220, they can be retained at a location that does not interfere with the operation of the impeller 220. For example, the pad 272 and/or the pad 276 can provide a surface that retains particles upon contact of the particle with the pad 272 and/or the pad 276. For example, the pad 272 and/or the pad 276 can include an adhesive (e.g., pressure-sensitive adhesive). As used herein, an adhesive can include any material that has adhesion properties and/or stickiness, such as a polymer, glue, cement, paste, laminate, and/or other material that bonds to particles upon contact therewith. By further example, the pad 272 and/or the pad 276 can include an uncured or partially cured substance that is exposed to the interior space 280, the openings 270 of the base plate 230, and/or the openings of the impeller 220. In some embodiments, the fan 200 can include one or more other retention mechanisms, such as an operable electrode or other surface that is configured to electrically charged to attract particles. Additionally or alternatively, the fan 200 can include a filter and/or a mechanically actuated container for selectively containing particles that migrate out of the interior space 280, through the openings 270, and/or through the openings of the impeller 220.

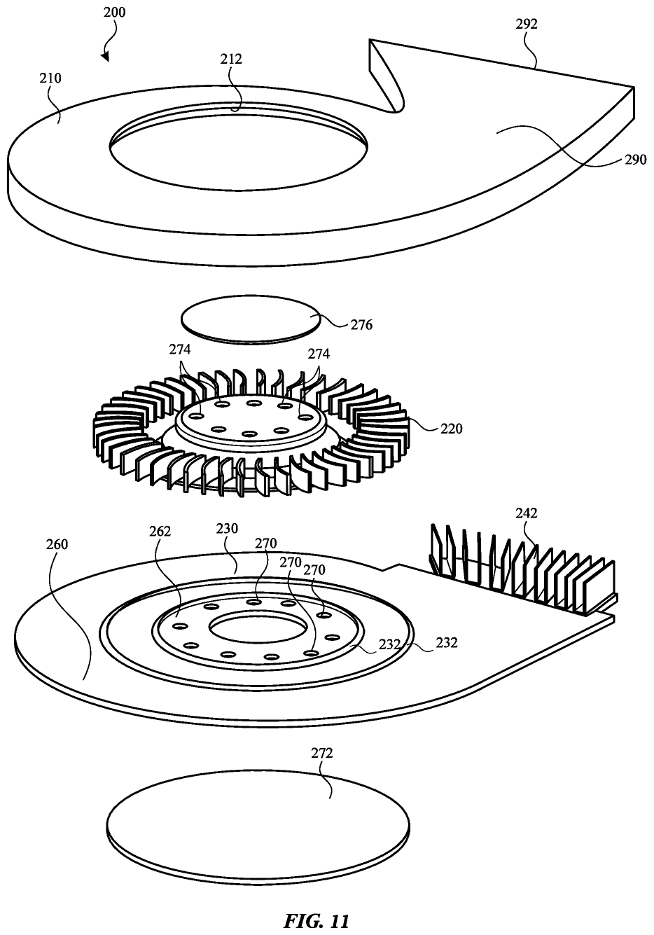

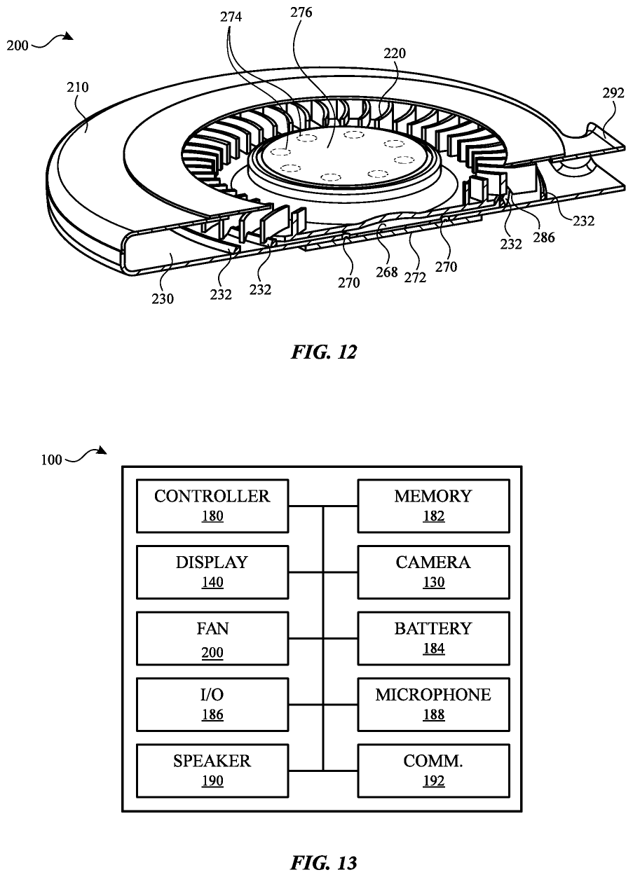

Referring now to FIGS. 11 and 12, a fan can provide multiple features that provide particle mitigation properties. For example, the fan 200 of FIGS. 11 and 12 includes one or more protrusions 232 extending from the base plate 230 to block and/or redirect a pathway of an incoming particle. Such protrusion(s) 232 can include any one or more features described herein with respect to the fan of FIG. 5 or 6.

By further example, the fan 200 of FIGS. 11 and 12 includes a base plate 230 having a variable profile at different portions thereof and with respect to the impeller 220, such as with a base plate central portion 262 and one or more base plate peripheral portions 260. Along with features of the impeller 220, the base plate 230 can define different distances there between, as described with respect to the fan of FIG. 7.

By further example, the fan 200 of FIGS. 11 and 12 includes a base plate 230 that defines one or more openings 270 extending entirely through the base plate 230. Such openings 270 can include any one or more features described herein with respect to the fan of FIG. 8.

By further example, the fan 200 of FIGS. 11 and 12 includes a pad 272 on an outer side of the base plate 230 to capture particles that pass from the interior space 280 and through the openings 270. The pad 272 can include any one or more features described herein with respect to the fan of FIGS. 9 and 10.

By further example, the fan 200 of FIGS. 11 and 12 includes an impeller 220 that defines one or more openings 274 extending entirely through the impeller 220. Such openings 274 can include any one or more features described herein with respect to the fan of FIG. 8.

By further example, the fan 200 of FIGS. 11 and 12 includes a pad 276 on an outer side of the impeller 220 to capture particles that pass from the interior space 280 and through the openings 274. The pad 276 can include any one or more features described herein with respect to the fan of FIGS. 9 and 10.

It will be understood that any number of features described herein can be combined in a single fan to provide particle mitigation. It will be further understood that no one feature is necessary to provide effective particle mitigation to a fan.

Referring now to FIG. 13, components of the head-mountable device can be operably connected to provide the performance described herein. FIG. 13 shows a simplified block diagram of an illustrative head-mountable device 100 in accordance with one embodiment of the invention. It will be appreciated that components described herein can be provided on either or both of a frame and/or a head engager of the head-mountable device 100. It will be understood that additional components, different components, or fewer components than those illustrated may be utilized within the scope of the subject disclosure.

As shown in FIG. 13, the head-mountable device 100 can include a controller 180 with one or more processing units that include or are configured to access a memory 182 having instructions stored thereon. The instructions or computer programs may be configured to perform one or more of the operations or functions described with respect to the head-mountable device 100. The controller 180 can be implemented as any electronic device capable of processing, receiving, or transmitting data or instructions. For example, the controller 180 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly 214 configured to help optically adjust and correctly project the image-based content being displayed by the display 140 for close up viewing. The optical subassembly 214 can include one or more lenses, mirrors, or other optical devices.

The head-mountable device 100 can include the fan 200 and/or any other suitable component for cooling down components of the head-mountable device 100. Suitable components can include, for example, impellers, pipes for transferring heat, vents, apertures, holes, any other component suitable for distributing and diffusing heat, or any combination thereof. The fan 200 may also or instead be manufactured from materials selected for heat dissipation properties. For example, a housing of the head-mountable device 100 may be configured to distribute heat away from components thereof and/or the user.

The head-mountable device 100 can include a battery 184, which can charge and/or power components of the head-mountable device 100. The battery 184 can also charge and/or power components connected to the head-mountable device 100.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the controller 180 for detection of sound levels and communication of detections for further processing, as described further herein.

The head-mountable device 100 can include the speakers 190 as described herein. The speakers 190 can be operably connected to the controller 180 for control of speaker output, including sound levels, as described further herein.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include a camera which can capture image based content of the outside world.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

While various embodiments and aspects of the present disclosure are illustrated with respect to a head-mountable device, it will be appreciated that the subject technology can encompass and be applied to other devices. For example, a noise mitigation system in accordance with embodiments disclosed herein can be included with an electronic device that generates heat during operation. Such an electronic device can be or include a desktop computing device, a laptop-computing device, a display, a television, a portable device, a phone, a tablet computing device, a mobile computing device, a wearable device, a watch, and/or a digital media player. Such devices can include an impeller and flow channels to facilitate cooling as described herein.

Accordingly, embodiments of the present disclosure provide a head-mountable device that provides a fan that effectively manages heat while also mitigating the intrusion of particles and other debris. Fans can include a protrusion that creates a tortuous pathway to direct incoming particles away from sensitive regions. Fans can include openings to allow particles to exit the impeller. Fans can include a variable spacing between the impeller and the base plate to avoid collection of particles. Fans can include an adhesive pad that collects and retains particles at a location that does not interfere with operation of the impeller.

Various examples of aspects of the disclosure are described below as clauses for convenience. These are provided as examples, and do not limit the subject technology.
Clause A: a fan comprising: a cover defining an inlet; a base plate positioned opposite the cover; an impeller within an interior space between the cover and the base plate, the impeller being operable to direct air from the inlet to an outlet; and an annular ring extending from the base plate towards the cover and surrounding at least a portion of the impeller.
Clause B: a fan comprising: a cover defining an inlet; a base plate positioned opposite the cover; an impeller comprising blades between the cover and the base plate, the blades forming notches, the impeller being operable to direct air from the inlet to an outlet; and a protrusion extending from the base plate and into at least some of the notches, wherein the protrusion is positioned between the outlet and a portion of the impeller.
Clause C: a fan comprising: a cover defining an inlet; a base plate positioned opposite the cover, the base plate defining openings that extend entirely through the base plate; an impeller within an interior space between the cover and the base plate, the impeller overlapping at least some of the openings of the base plate; and a pad on a side of the openings opposite the impeller, the pad providing an adhesive exposed to the openings.

One or more of the above clauses can include one or more of the features described below. It is noted that any of the following clauses may be combined in any combination with each other, and placed into a respective independent clause, e.g., clause A, B, or C.
Clause 1: the annular ring defines a surface facing away from the impeller and forming an angle that is oblique with respect to the base plate.
Clause 2: a portion of the annular ring is positioned between the impeller and the outlet.
Clause 3: a distance between the annular ring and the impeller is smaller than a distance between the base plate and the impeller.
Clause 4: the annular ring surrounds an outermost periphery of the impeller.
Clause 5: the base plate comprises a base plate central portion and a base plate peripheral portion; and the impeller comprises an impeller central portion and an impeller peripheral portion, wherein a distance between the base plate central portion and the impeller central portion is greater than a distance between the base plate peripheral portion and the impeller peripheral portion.
Clause 6: the impeller comprises a support disk and blades extending from the support disk, wherein the annular ring encircles the support disk.
Clause 7: the impeller being configured to rotate within a plane of rotation; and the protrusion is at least partially within the plane of rotation of the impeller.
Clause 8: the protrusion is an annular protrusion surrounding a portion of the impeller.
Clause 9: the base plate defines openings that extend entirely through the base plate, the impeller overlapping at least some of the openings of the base plate.
Clause 10: a pad on a side of the openings opposite the impeller, the pad providing an adhesive exposed to the openings.
Clause 11: the impeller further comprises a support disk with the blades extending from the support disk, wherein the protrusion is an annular protrusion encircling the support disk.
Clause 12: a portion of the adhesive couples the pad to the base plate.
Clause 13: an annular ring extending from the base plate towards the cover.
Clause 14: the impeller further comprises a support disk with the blades extending from the support disk, wherein the annular ring encircles the support disk and overlaps the blades.
Clause 15: the annular ring is a first annular ring, the fan further comprising a second annular ring extending from the base plate towards the cover, wherein the second annular ring encircles the support disk and the blades.
Clause 16: a distance between a central impeller portion and a central base plate portion is greater than a distance between a peripheral impeller portion and a peripheral base plate portion.
Clause 17: the openings are positioned along the central base plate portion and within the first annular ring and the second annular ring.
Clause 18: an additional pad on a side of the impeller that is opposite the base plate, the additional pad providing an additional adhesive exposed to additional openings extending through the impeller.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A fan comprising:
a cover defining an inlet;
a base plate positioned opposite the cover;
an impeller within an interior space between the cover and the base plate, the impeller being operable to direct air from the inlet to an outlet; and
an annular ring extending from the base plate towards the cover and surrounding at least a portion of the impeller.

2. The fan of claim 1, wherein the annular ring defines a surface facing away from the impeller and forming an angle that is oblique with respect to the base plate.

3. The fan of claim 1, wherein a portion of the annular ring is positioned between the impeller and the outlet.

4. The fan of claim 1, wherein a distance between the annular ring and the impeller is smaller than a distance between the base plate and the impeller.

5. The fan of claim 1, wherein the annular ring surrounds an outermost periphery of the impeller.

6. The fan of claim 1, wherein:
the base plate comprises a base plate central portion and a base plate peripheral portion; and
the impeller comprises an impeller central portion and an impeller peripheral portion, wherein a distance between the base plate central portion and the impeller central portion is greater than a distance between the base plate peripheral portion and the impeller peripheral portion.

7. The fan of claim 1, wherein the impeller comprises a support disk and blades extending from the support disk, wherein the annular ring encircles the support disk.

8. A fan comprising:
a cover defining an inlet;
a base plate positioned opposite the cover;
an impeller comprising blades between the cover and the base plate, the blades forming notches, the impeller being operable to direct air from the inlet to an outlet; and
a protrusion extending from the base plate and into at least some of the notches, wherein the protrusion is positioned between the outlet and a portion of the impeller.

9. The fan of claim 8, wherein:
the impeller being configured to rotate within a plane of rotation; and
the protrusion is at least partially within the plane of rotation of the impeller.

10. The fan of claim 8, wherein the protrusion is an annular protrusion surrounding a portion of the impeller.

11. The fan of claim 8, wherein the base plate defines openings that extend entirely through the base plate, the impeller overlapping at least some of the openings of the base plate.

12. The fan of claim 10, further comprising a pad on a side of the openings opposite the impeller, the pad providing an adhesive exposed to the openings.

13. The fan of claim 8, wherein the impeller further comprises a support disk with the blades extending from the support disk, wherein the protrusion is an annular protrusion encircling the support disk.

14. A fan comprising:
a cover defining an inlet;
a base plate positioned opposite the cover, the base plate defining openings that extend entirely through the base plate;
an impeller within an interior space between the cover and the base plate, the impeller overlapping at least some of the openings of the base plate; and
a pad on a side of the openings opposite the impeller, the pad providing an adhesive exposed to the openings.

15. The fan of claim 14, further comprising an additional pad on a side of the impeller that is opposite the base plate, the additional pad providing an additional adhesive exposed to additional openings extending through the impeller.

16. The fan of claim 15, further comprising an annular ring extending from the base plate towards the cover.

17. The fan of claim 16, wherein the impeller further comprises a support disk with the blades extending from the support disk, wherein the annular ring encircles the support disk and overlaps the blades.

18. The fan of claim 17, wherein the annular ring is a first annular ring, the fan further comprising a second annular ring extending from the base plate towards the cover, wherein the second annular ring encircles the support disk and the blades.

19. The fan of claim 18, wherein a distance between a central impeller portion and a central base plate portion is greater than a distance between a peripheral impeller portion and a peripheral base plate portion.

20. The fan of claim 19, wherein the openings are positioned along the central base plate portion and within the first annular ring and the second annular ring.
